(19) United States
(12) Patent Application Publication
(10) Pub. No.: US 2016/0123762 A1
(43) Pub. Date: May 5, 2016

(54) NAVIGATION DEVICE, VEHICLE HAVING THE SAME, AND METHOD FOR CONTROLLING VEHICLE

(71) Applicants: HYUNDAI MOTOR COMPANY, Seoul (KR); KIA MOTORS CORPORATION, Seoul (KR)

(72) Inventor: Se Min OH, Seoul (KR)

(21) Appl. No.: 14/861,640

(22) Filed: Sep. 22, 2015

(30) Foreign Application Priority Data
Nov. 4, 2014 (KR) 10-2014-0151806

(51) Int. Cl. G01C 21/36; B60N 2/44; B60H 1/00; G07C 5/12

(52) U.S. Cl. CPC G01C 21/3697; G01C 21/3664; G07C 5/12; B60N 2/44; B60H 1/00735; B60H 1/00985

(57) ABSTRACT

A navigation device includes a reception unit configured to receive vehicle information including a position of a steering wheel of a vehicle; a determination unit configured to determine positions of a driver's seat and a passenger seat of the vehicle based on the received vehicle information; and a display unit configured to display the positions of the driver's seat and the passenger seat in the vehicle based on the determination result.

### CROSS-REFERENCE TO RELATED APPLICATION

This application claims priority to and the benefit of Korean Patent Application No. 10-2014-0151806, filed on Nov. 4, 2014 in the Korean Intellectual Property Office, the disclosure of which is incorporated herein by reference.

### TECHNICAL FIELD

The present disclosure relates to a navigation device configured to display positions of a driver's seat and a passenger seat on a screen through a display, a vehicle including the same, and a method of controlling the vehicle.

### BACKGROUND

In recent times, a navigation device is generally built in a vehicle. The navigation device can provide a user with a route to a destination, and can display various control screens related to control of apparatuses installed in the vehicle or screens related to additional functions that can be performed by the navigation device. Accordingly, research on technologies of controlling the apparatuses in the vehicle through the navigation device is being conducted.

### SUMMARY

Accordingly, it is an aspect of the present invention to provide a navigation device configured to adaptively determine positions of a driver's seat and a passenger seat according to a position at which a steering wheel of a vehicle is installed, a vehicle including the same, and a method of controlling the vehicle.

Additional aspects of the invention will be set forth in part in the description which follows and, in part, will be obvious from the description, or may be learned by practice of the invention.

In accordance with one aspect of the present invention, a navigation device includes a reception unit configured to receive vehicle information including a position of a steering wheel installed in a vehicle; a determination unit configured to determine positions of a driver's seat and a passenger seat of the vehicle based on the received vehicle information; and a display unit configured to display the positions of the driver's seat and the passenger seat in the vehicle based on the determination result.

In addition, the reception unit may receive the vehicle information from an air conditioning apparatus through a controller area network (CAN).

In addition, the vehicle information may include part information of the steering wheel installed in the vehicle.

In addition, the reception unit may receive the vehicle information transmitted from an air conditioning apparatus after booting of the navigation device is complete, or receive the vehicle information transmitted from the air conditioning apparatus before the booting of the navigation device is complete.

In addition, the display unit may display the positions of the driver's seat and the passenger seat in the vehicle through the display of the navigation device.

In addition, the display unit may generate a user interface constituting a screen of a display corresponding to the positions of the driver's seat and the passenger seat in the vehicle.

In addition, the display unit may display the generated user interface on the screen.

In accordance with another aspect of the present invention, a vehicle includes a reception unit configured to receive vehicle information including a position of a steering wheel of the vehicle; a determination unit configured to determine positions of a driver's seat and a passenger seat of the vehicle based on the received vehicle information; and a display unit configured to display the positions of the driver's seat and the passenger seat in the vehicle based on the determination result.

In addition, the reception unit may receive the vehicle information from an air conditioning apparatus through a CAN.

In addition, the vehicle information may include part information of the steering wheel installed in the vehicle.

In addition, the reception unit may receive the vehicle information transmitted from the air conditioning apparatus after booting of a navigation device installed in the vehicle is complete, or receive the vehicle information transmitted from the air conditioning apparatus before the booting of the navigation device is complete.

In addition, the display unit may display the positions of the driver's seat and the passenger seat in the vehicle through the display of the navigation device installed in the vehicle.

In addition, the display unit may generate a user interface constituting a screen of the display corresponding to the positions of the driver's seat and the passenger seat in the vehicle.

In addition, the display unit may display the generated user interface on the screen.

In accordance with another aspect of the present invention, a method of controlling a vehicle includes receiving vehicle information including a position of a steering wheel of the vehicle; determining positions of a driver's seat and a passenger seat of the vehicle based on the received vehicle information; and displaying the positions of the driver's seat and the passenger seat in the vehicle based on the determination result.

In addition, receiving the vehicle information may include receiving the vehicle information from an air conditioning apparatus through a CAN.

In addition, the vehicle information may include part information of the steering wheel installed in the vehicle.

In addition, receiving the vehicle information may include receiving the vehicle information transmitted from the air conditioning apparatus after booting of a navigation device installed in the vehicle is complete, or receiving the vehicle information transmitted from the air conditioning apparatus before the booting of the navigation device is complete.

In addition, displaying the positions may include generating a user interface constituting a screen of a display to correspond to the positions of the driver's seat and the passenger seat in the vehicle.

In addition, displaying the positions may further include displaying the generated user interface on the screen.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically showing an external configuration of a vehicle according to an embodiment of the present disclosure;

FIG. 2 is a view showing an internal configuration of the vehicle having a steering wheel installed on a left side of a vehicle according to an embodiment of the present disclosure;

FIG. 3 is a block diagram of a navigation device configured to adaptively determine positions of a driver's seat and a passenger seat in a vehicle according to a position of a steering wheel of a vehicle and provide the positions to a user, according to an embodiment of the present disclosure;

FIG. 4 is a view showing a block diagram of a vehicle in which a navigation device according to an embodiment of the present disclosure is installed;

FIG. 5 is a view showing a control screen of an air conditioning apparatus when a driver's seat according to an embodiment of the present disclosure is disposed on a left side of the control screen;

FIG. 6 is a view showing an internal configuration of a vehicle in which a steering wheel according to an embodiment of the present disclosure is installed on a right side of a vehicle;

FIG. 7 is a view showing a control screen of an air conditioning apparatus when the driver's seat according to an embodiment of the present disclosure is disposed on a right side of the control screen;

FIG. 8 is a view showing a screen displaying a user interface in which the control screen of the air conditioning apparatus is disposed together with other information of the vehicle, according to an embodiment of the present disclosure;

FIG. 9 is a view showing an operation flow chart of a method of controlling the vehicle when the air conditioning apparatus is turned ON before booting of the navigation device is complete, according to an embodiment of the present disclosure;

FIG. 10 is a view showing an operation flow chart of a method of controlling the vehicle when the air conditioning apparatus is turned ON after booting of the navigation device is complete, according to an embodiment of the present disclosure; and

FIG. 11 is a view showing an operation flow chart of a method of controlling the vehicle such that positions of the driver's seat and the passenger seat in the vehicle are adaptively determined according to the position of the steering wheel of the vehicle and provided to a user, according to an embodiment of the present disclosure.

### DETAILED DESCRIPTION

Reference will now be made in detail to the embodiments of the present invention, examples of which are illustrated in the accompanying drawings, wherein like reference numerals refer to like elements throughout.

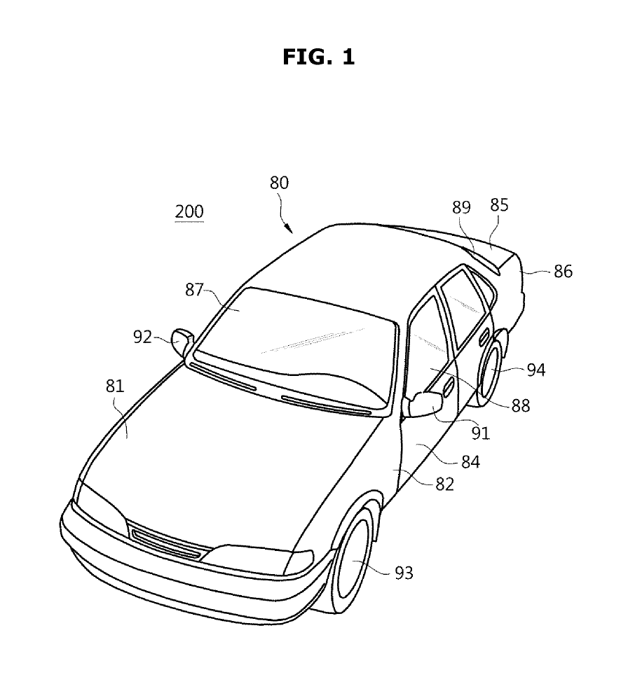

FIG. 1 is a view schematically showing an external configuration of a vehicle according to an embodiment of the present disclosure.

Referring to FIG. 1, a vehicle 200 includes a vehicle body 80 forming the exterior of the vehicle 200, and wheels 93 and 94 configured to move the vehicle 200. The vehicle body 80 includes a hood 81, front fenders 82, doors 84, a trunk lid 85, quarter panels 86, and so on.

In addition, the vehicle 200 includes a front window 87 installed in the front of the vehicle body 80 to provide a field of vision in front of the vehicle 200, side mirrors 91 and 92 installed in the doors 84 to provide a field of vision of sides of the vehicle 200, and a rear window 89 installed in the rear of the vehicle body 80 to provide a field of vision behind the vehicle 200 may be provided at the outside of the vehicle body 80. Each of the doors 84 may include a side window 88. Hereinafter, an internal configuration of the vehicle will be described in detail.

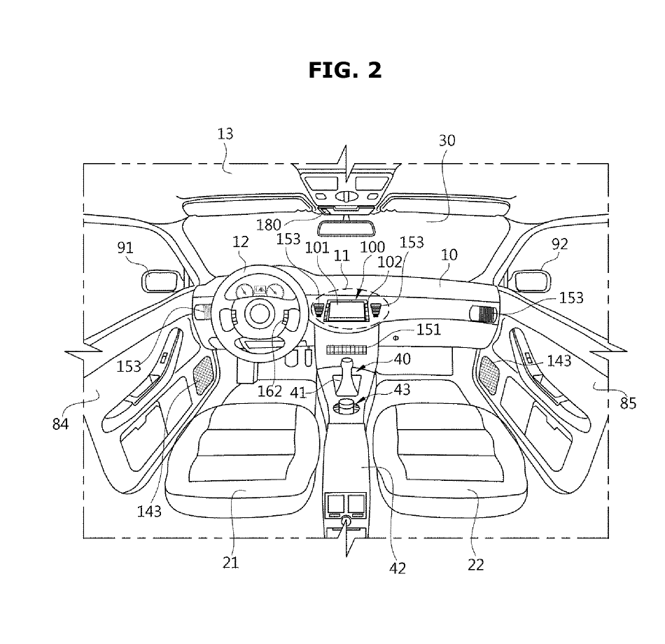

FIG. 2 is a view showing the internal configuration of the vehicle in which a steering wheel is installed on a left side of the vehicle according to an embodiment of the present disclosure.

Referring to FIG. 2, a navigation device 100 can provide a user with a route to a destination. In addition, the navigation device 100 can display various control screens related to control of apparatuses installed in the vehicle 200 or screens related to additional functions that can be performed by the navigation device 100.

For example, the navigation device 100 may be an audio video navigation (AVN) device. The AVN device is a device capable of integrally performing functions of audio, video and navigation devices. The AVN device can selectively display at least one of an audio screen, a video screen and a navigation screen through a display 101, and can display various control screens related to control of the vehicle 200 or screens related to additional functions that can be performed by the AVN device. According to the embodiment, the AVN device can be interlocked to the air conditioning apparatus to display various control screens related to control of an air conditioning apparatus through the display 101.

The display 101 may be disposed in a center fascia 11, which is a central region of a dashboard 10. According to the embodiment, the display 101 may be implemented as a liquid crystal display (LCD), a light emitting diode (LED), a plasma display panel (PDP), an organic light emitting diode (OLED), a cathode ray tube (CRT), or the like.

A speaker 143 configured to output sound may be provided in the vehicle 200. Accordingly, the vehicle 200 can output sound needed for performing an audio function, a video function, a navigation function and other additional functions through the speaker 143. According to the embodiment, the navigation device 100 can provide information related to a temperature or the like in the vehicle 200 and an operation state or the like of the air conditioning apparatus to a user through the speaker 143.

A navigation input unit 102 may be disposed in the center fascia 11, which is a central region of the dashboard 10. A driver can input various control orders by manipulating the navigation input unit 102. According to the embodiment, a passenger can input a control order capable of setting a temperature of the air conditioning apparatus by manipulating the navigation input unit 102.

In addition, the navigation input unit 102 may be provided as a hard key type in a region adjacent to the display 101. When the display 101 is implemented as a touch screen type, the display 101 can also perform a function of the navigation input unit 102.

Meanwhile, a center input unit 43 of a jog shuttle type or a hard key type may be provided on a center console 40. The center console 40 is disposed between a driver's seat 21 and a passenger seat 22, and has a gear manipulation lever 41 and a tray 42. The center input unit 43 may perform some or all functions of the navigation input unit 102.

A voice input unit 180 can receive voice input uttered by a driver through a microphone of the voice input unit 180 to convert the voice input into an electrical signal. In order to effectively input the voice, the voice input unit 180 may be mounted on a head lining 13 as shown in FIG. 2, but is not limited thereto and may be mounted on the dashboard 10, a steering wheel 12, or the like, as long as a voice order of the driver during driving can be input.

Accordingly, the navigation device 100 can control various devices installed in the vehicle 200 according to touch input of the user detected through the display 101, voice input of the user received through the voice input unit 180, or a control order of the user received through the navigation input unit 102. In addition, the navigation device 100 may control the various devices installed in the vehicle 200 according to the control order input by the user through a jog shuttle type or hard key type controller.

An air conditioning apparatus may be installed in the vehicle 200 to perform both heating and cooling, and can discharge heated or cooled air through a ventilation hole 153 to control a temperature in the vehicle 200.

The air conditioning apparatus to be described below is an apparatus for detecting an indoor/outdoor environmental condition of the vehicle 200, suction/exhaust of air, circulation, cooling/heating states, and so on, and automatically controlling the temperature or the like in the vehicle 200 or controlling the temperature or the like in the vehicle 200 according to a control order of the user. The air conditioning apparatus may be installed in the vehicle 200 to individually control the temperature or the like with respect to the driver's seat 21 and the passenger seat 22.

According to the embodiment, the air conditioning apparatus may be a dual-zone automatic temperature controller (DATC). The DATC is a full automatic temperature control device configured to automatically set temperatures of the driver's seat 21 and the passenger seat 22, or set the temperatures according to a control order of the user. The vehicle 200 can individually control environments such as the temperature or the like with respect to the driver's seat 21 and the passenger seat 22, on which a passenger sits, using the DATC to provide convenience to those aboard the vehicle.

For example, the temperatures at the driver's seat 21 and the passenger seat 22 may be different from each other according to a position of the sun. Accordingly, a driver who sits on the driver's seat 21 may feel hot while a passenger who sits on the passenger seat 22 may not feel as hot as the driver. Accordingly, the navigation device 100 can be interlocked with the air conditioning apparatus to individually control the temperatures or the like with respect to the driver's seat 21 and the passenger seat 22 to provide convenience to those aboard the vehicle. Here, when the navigation device 100 is interlocked with the air conditioning apparatus to display the control screens of the passenger seat 22 and the driver's seat 21, positions of the passenger seat 22 and the driver's seat 21 displayed on the screen may differ according to a position of a steering wheel 12. This will be described below.

The control order of the user for controlling the temperature may be input through an air-conditioning input unit 151. In addition, the air conditioning apparatus may be interlocked with the navigation device 100 to control the temperature in the vehicle 200 according to the control order of the user received through the display 101. In addition, the air conditioning apparatus may be interlocked with the navigation device 100 to control the temperature in the vehicle 200 according to a voice order of the user received through the voice input unit 180. In addition, the air conditioning apparatus may be connected to the navigation device 100 to control the temperature in the vehicle 200 according to the control order received through the jog shuttle type or hard key type controller.

The air conditioning apparatus can individually control the temperatures of the driver's seat 21 and the passenger seat 22 through the ventilation hole 153. In addition, the air conditioning apparatus may be interlocked with the navigation device 100 to display the control screen of the driver's seat 21, or the passenger seat 22 related to the air conditioning apparatus through the display 101. Hereinafter, the navigation device 100 will be described in detail.

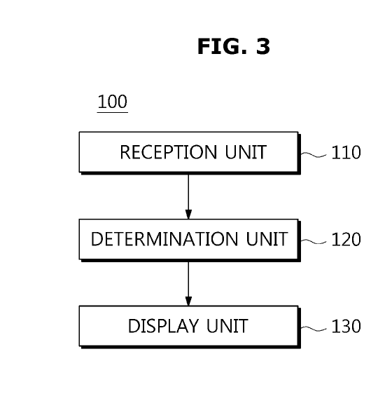

FIG. 3 is a block diagram of the navigation device configured to adaptively determine positions of the driver's seat and the passenger seat in the vehicle according to a position of the steering wheel of the vehicle to provide the positions to the user, according to an embodiment of the present disclosure.

As shown in FIG. 3, the navigation device 100 includes a reception unit 110, a determination unit 120 and a display unit 130. The reception unit 110, the determination unit 120 and the display unit 130 may be integrated on a system on chip built in the navigation device 100.

The reception unit 110 can receive vehicle information from the air conditioning apparatus. The vehicle information to be described below is information related to the position of the steering wheel of the vehicle. The vehicle information is information that enables the steering wheel installed in the vehicle to be identified, including part information of the steering wheel installed in the vehicle. However, the vehicle information is not limited thereto but may include any information that enables the steering wheel installed in the vehicle to be identified.

A steering wheel installed in the vehicle may be disposed on a left side or a right side in the vehicle. Hereinafter, when the front window is seen from the inside of the vehicle, a vehicle in which the steering wheel is installed on a left side is referred to as a left-hand drive (LHD) vehicle and a vehicle in which the steering wheel is installed on a right side is referred to as a right-hand drive (RHD) vehicle.

According to the embodiment, positions of the steering wheels differ by country. That is, specifications of the vehicles are determined according to countries. Specifically, the steering wheel is designated to be installed in the right side in RHD countries such as the United Kingdom, Japan, Australia, and so on, and installed on the left side in LHD countries such as Korea, the US, and so on.

Accordingly, the LHD and RHD vehicles have different vehicle specifications. Specifically, since the LHD and RHD vehicles are designed differently, specifications of the built-in parts are different from each other, and part numbers may also be different from each other. Here, the air conditioning apparatus may be designed according to the vehicle specifications. Accordingly, the air conditioning apparatus may store information related to the vehicle specification, i.e., vehicle information related to the position of the steering wheel.

The reception unit 110 can receive vehicle information from the air conditioning apparatus through a network in the vehicle. According to the embodiment, the reception unit 110 can receive the vehicle information from the air conditioning apparatus through a controller area network (CAN).

The CAN is a network for a vehicle configured to provide digital direct communication between various control equipment of the vehicle, and a communication network configured to provide communication in real time by substituting complex electrical interconnections and relays of electrical parts in the vehicle with direct communication wires. However, the network is not limited to the embodiment but the vehicle information can be received from the air conditioning apparatus through various networks usable in the vehicle.

The determination unit 120 can determine positions of the driver's seat and the passenger seat in the vehicle using the received vehicle information. For example, the determination unit 120 can identify whether the vehicle is an LHD vehicle or an RHD vehicle using the part numbers included in the vehicle information, and can determine the positions of the driver's seat and the passenger seat based on the identification result.

According to the embodiment, when the steering wheel in the vehicle is disposed on the left side when viewing the front window from the inside of the vehicle, the determination unit 120 can determine the left seat in the vehicle as the driver's seat, and determine the right seat in the vehicle as the passenger seat. As another example, when the steering wheel in the vehicle is disposed on the right side when viewing the front window from the inside of the vehicle, the determination unit 120 can determine the right seat in the vehicle as the driver's seat, and determine the left seat in the vehicle as the passenger seat. That is, the determination unit 120 can determine the seat corresponding to the position at which the steering wheel is installed as the driver's seat, and determine the other seat as the passenger seat.

The determination unit 120 can identify the position at which the steering wheel is installed in the vehicle using the vehicle information, and can determine the positions of the driver's seat and the passenger seat in the vehicle according to the identification result. That is, whether the steering wheel is installed on the left side or the right side, the determination unit 120 can adaptively determine the positions of the driver's seat and the passenger seat according to the position at which the steering wheel is installed. In other words, the determination unit 120 may be able to identify which seat, the driver's seat or the passenger's seat, is the left seat in the vehicle and which seat, the drivers' seat or the passenger's seat, is the right seat in the vehicle.

According to the embodiment, the determination unit 120 can identify whether the vehicle is an LHD vehicle or an RHD vehicle using the part number included in the vehicle information. Accordingly, when the vehicle is determined as an LHD vehicle, the determination unit 120 can determine the left seat in the vehicle as the driver's seat, and determine the right seat in the vehicle as the passenger seat.

Alternatively, when the vehicle is determined as an RHD vehicle, the determination unit 120 can determine the left seat in the vehicle as the passenger seat, and determine the right seat in the vehicle as the driver's seat. The information included in the vehicle information is not limited to the embodiment but the vehicle information includes various kinds of information that enable the steering wheel installed in the vehicle to be identified.

The display unit 130 can control the screen provided through the display to correspond to the determination result of the driver's seat and the passenger seat in the vehicle. For example, when the positions of the driver's seat and passenger seat are varied, the display unit 130 can vary the positions of the driver's seat and the passenger seat to display the positions on the screen. Accordingly, whether the steering wheel is installed on the left side or the right side of the vehicle, the display unit 130 can adaptively control the screen to display the positions of the driver's seat and the passenger seat on the screen to the user.

According to the embodiment, the display unit 130 can generate a user interface (UI) constituting the screen provided through the display to correspond to the positions of the driver's seat and the passenger seat. The user interface is an environment in which users can conveniently use and control a specific device or system, and the users can more conveniently input orders or the like in the screen or receive services. For example, the display unit 130 can be disposed on the screen such that the user can easily use icons or the like that can receive orders of the devices installed in the vehicle or can provide services using the user interface.

The display unit 130 can display the user interface including the information related to the positions of the driver's seat and the passenger seat through the display on the screen such that passengers can more conveniently recognize the information related to the driver's seat and the passenger seat and can easily input the control order related to the driver's seat and the passenger seat.

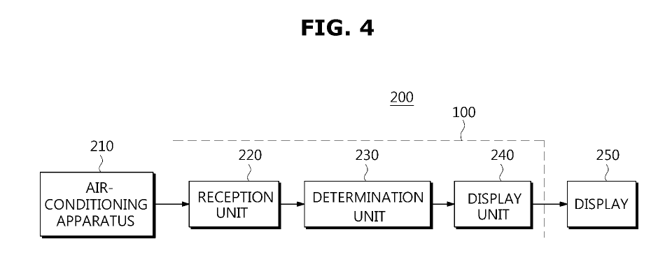

FIG. 4 is a view showing a block diagram of the vehicle in which the navigation device is installed, according to an embodiment of the present disclosure.

As shown in FIG. 4, the vehicle 200 may include an air conditioning apparatus 210, a navigation device 100 including a reception unit 220, a determination unit 230, and a display unit 240, and a display 250. The reception unit 220, the determination unit 230 and the display unit 240 may be integrated on a system on chip installed in the vehicle 200.

The reception unit 220 can receive the vehicle information from the air conditioning apparatus 210. In addition, the determination unit 230 can determine the positions of the driver's seat and the passenger seat in the vehicle using the vehicle information. The reception unit 220 and the determination unit 230 are the same as described in FIG. 3, and thus detailed description thereof will be omitted.

The display unit 240 can control the display 250 to display the positions of the driver's seat and the passenger seat on the screen. The display 250 includes all displays installed in the vehicle 200. The display 250 may be implemented as an LCD, an LED, a PDP, an OLED, a CRT, and so on.

According to the embodiment, the display unit 240 may be interlocked with the air conditioning apparatus 210 to generate the user interface including the control screen capable of controlling the temperatures or the like of the driver's seat and the passenger seat. The display unit 240 can display the user interface on the screen through the display 250. Accordingly, the display unit 240 allows the passenger in the vehicle to easily set the temperatures of the driver's seat and the passenger seat individually.

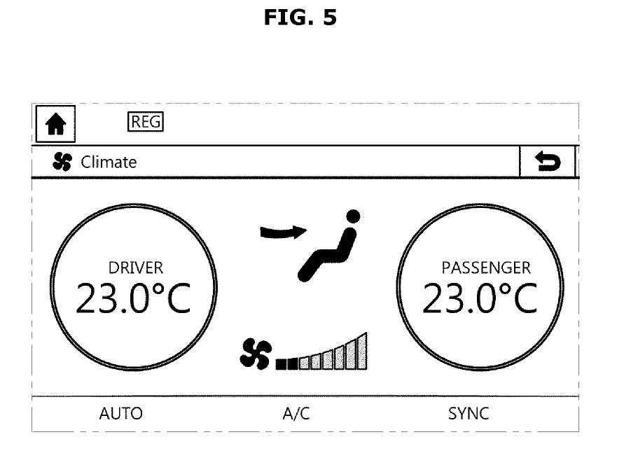

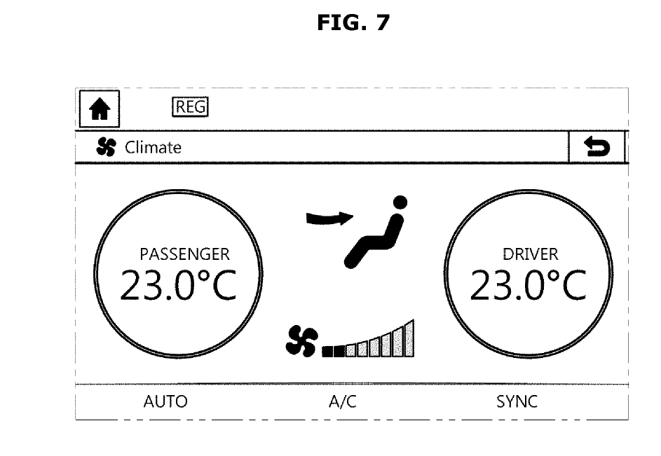

According to the embodiment, FIG. 5 is a view showing the screen that displays the user interface when the driver's seat in the vehicle is on the left side of the screen. As another example, FIG. 7 is a view showing the screen that displays the user interface when the driver's seat in the vehicle is on the right side of the screen.

The vehicle can display the control screen related to the air conditioning apparatus through the display in the vehicle. According to the embodiment, as shown in FIG. 2, when the steering wheel 12 is installed on the left side when the front window 87 is seen from the inside of the vehicle, the vehicle can determine the seat installed on the left side of the vehicle as the driver's seat 21, and determine the seat installed on the right side as the passenger seat 22.

Then, as shown in FIG. 5, the vehicle can display the control screen that can set the temperature around the driver's seat on the left side of the screen, and display the control screen that can set the temperature around the passenger seat on the right side.

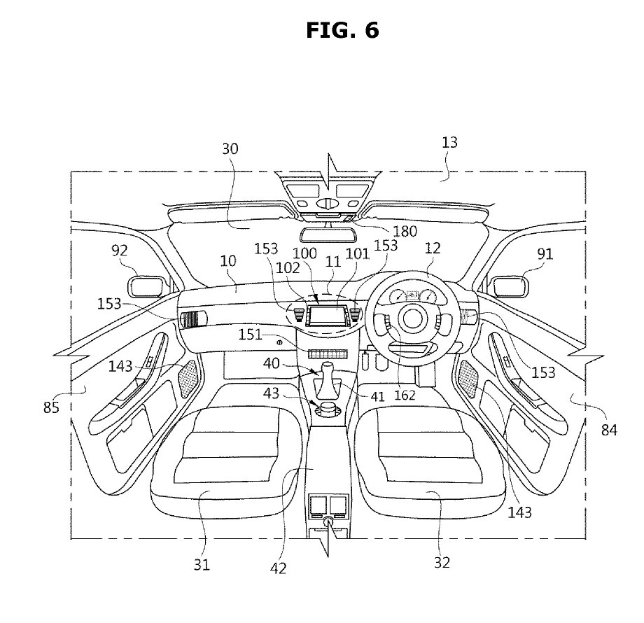

As another example, as shown in FIG. 6, when the front window 87 is seen from the inside of the vehicle, the steering wheel 12 in the vehicle can be installed on the right side of the vehicle. Here, the vehicle can determine the seat installed on the right side of the vehicle as a driver's seat 32, and determine the seat installed on the left side as a passenger seat 31.

Then, as shown in FIG. 7, the vehicle can display the control screen for setting the temperature around the driver's seat on the right side, and display the control screen for setting the temperature around the passenger seat on the left side such that those aboard the vehicle can more easily recognize them.

The vehicle can detect the touch input of the user on the display screen through the touch sensor to control a temperature, a wind direction, or the like, of the air-conditioning apparatus related to a region in which the touch input of the user is detected. For example, in FIG. 5, when the user touches a region in which “DRIVER” is displayed, the vehicle can detect the touch input of the user. Accordingly, the vehicle can display the screen for adjusting a temperature and intensity of wind around the driver's seat through the display. Alternatively, the vehicle can ask the user through the speaker about a level to which he or she wishes to adjust the temperature around the driver's seat or the intensity of the wind.

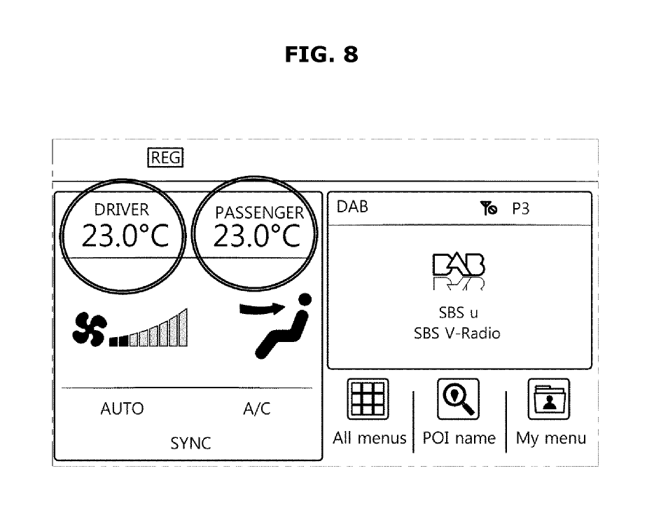

In addition, as shown in FIG. 8, the vehicle can display the user interface, in which the information related to the air conditioning apparatus and the information related to the other service are disposed through the display, on the screen. Referring to FIG. 8, the vehicle can display icons that can perform a DMB service, icons of services designated by the user, and so on, in addition to the information related to the air conditioning apparatus. That is, the method is not limited to the above-mentioned embodiments but various methods of constituting the user interface by the vehicle may be provided.

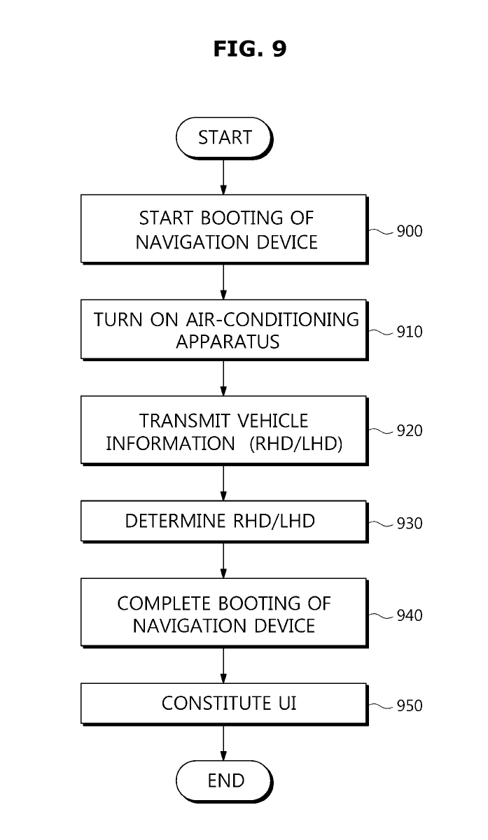

FIG. 9 is a view showing a method of controlling the vehicle when the air conditioning apparatus is turned ON before booting of the navigation device is complete, according to an embodiment of the present disclosure.

The navigation device can start booting to provide a service to a user (900). For example, when the navigation device is turned OFF or the vehicle starts, the booting of the navigation device can be started.

When the air conditioning apparatus is turned ON (910), the navigation device can receive vehicle information transmitted from the air conditioning apparatus (920). The vehicle information may include information related to the position of the steering wheel of the vehicle.

The navigation device can check whether the vehicle is an LHD vehicle or an RHD vehicle based on the vehicle information to determine the positions of the driver's seat and the passenger seat (930). For example, the navigation device can identify whether the vehicle is an LHD vehicle or an RHD vehicle using the part number included in the vehicle information to determine the positions of the driver's seat and the passenger seat.

When the booting of the navigation device is complete (940), the navigation device can constitute the user interface corresponding to the determination result (950). That is, even before the booting is complete, the navigation device can determine the positions of the driver's seat and the passenger seat based on the vehicle information after the vehicle information is previously received and the booting is complete.

For example, as shown in FIGS. 5 and 7, the navigation device can display the control screen of the air conditioning apparatus according to the positions of the driver's seat and the passenger seat through the display. As another example, as shown in FIG. 8, the navigation device can display the services provided by the navigation device in addition to the control screen of the air conditioning apparatus according to the positions of the driver's seat and the passenger seat through the display. The navigation device can constitute the user interface including the positions of the driver's seat and the passenger seat through various methods, and display the user interface through the display.

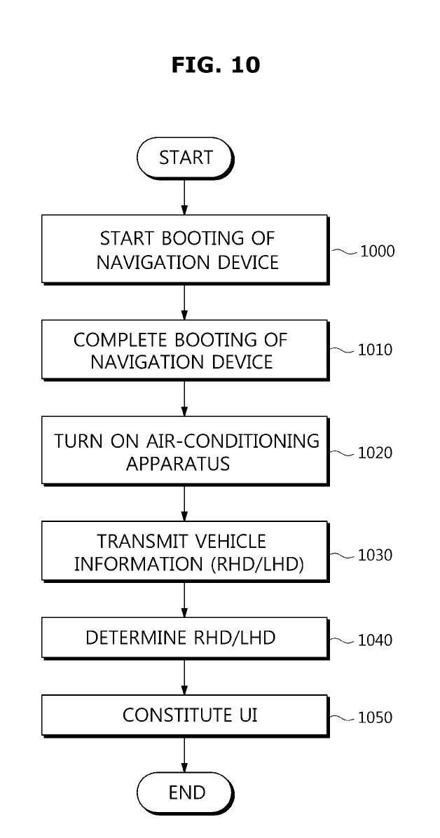

FIG. 10 is a view showing a method of controlling the vehicle when the air conditioning apparatus is turned ON, after the booting of the navigation device is complete, according to an embodiment of the present disclosure.

When the navigation device is turned ON or the vehicle is started, the navigation device can start booting to provide a service to the user (1000). When the booting of the navigation device is complete (1010), the air conditioning apparatus can be turned OFF (1020). Accordingly, the navigation device can receive the vehicle information transmitted from the air conditioning apparatus (1030). The vehicle information may include the information related to the specification of the vehicle such as whether the vehicle is an LHD vehicle or an RHD vehicle, or the like, i.e., the information related to the position of the steering wheel in the vehicle.

The navigation device can check whether the vehicle is an LHD vehicle or an RHD vehicle based on the vehicle information to determine the positions of the driver's seat and the passenger seat (1040). Accordingly, the navigation device can constitute the user interface corresponding to the determination result (1050).

Accordingly, even when the booting is completed before the air conditioning apparatus is turned ON, the navigation device can receive the vehicle information and constitute the user interface to correspond to the vehicle information after the air conditioning apparatus is turned ON. For example, even when the positions of the driver's seat and the passenger seat are incorrectly set, the navigation device can receive the vehicle information to constitute the user interface to correspond to the vehicle information.

As a specific example, as shown in FIG. 5, when the vehicle is initially set as an LHD vehicle, the navigation device can display the control screen in which “DRIVER” is disposed on the left side of the control screen and “PASSENGER” is disposed on the right side through the display. Accordingly, the navigation device can display the control screen in which positions of “DRIVER” and “PASSENGER” are varied as described in FIG. 7 when the vehicle is identified as an RHD vehicle by receiving the vehicle information.

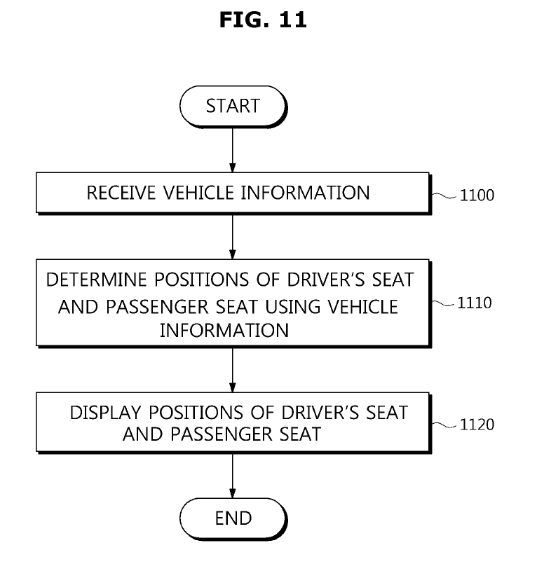

FIG. 11 is a view showing an operation flow chart of the method of controlling the vehicle provided to the user by adaptively determining the positions of the driver's seat and the passenger seat in the vehicle according to the position of the steering wheel of the vehicle according to the embodiment.

In step 1100, the vehicle can receive the vehicle information related to the position of the steering wheel from the air conditioning apparatus. The position of the steering wheel of the vehicle may differ according to regulations designated in different countries. Accordingly, the steering wheel of the vehicle may be installed on the left side or the right side even in the case of the same vehicle.

The air conditioning apparatus is an apparatus for controlling the temperature, and the air conditioning apparatus can store the vehicle information related to the position of the steering wheel of the vehicle to individually control the temperatures of the driver's seat and the passenger seat. As the vehicle information, the information that can identify the steering wheel installed in the vehicle can be stored. For example, the vehicle information may include the part number that can identify the specification of the steering wheel installed in the vehicle. However, the vehicle information is not limited thereto but includes various kinds of information that enables the steering wheel installed in the vehicle to be identified.

In step 1110, the vehicle can determine the positions of the driver's seat and the passenger seat using the vehicle information. The vehicle can check the position of the steering wheel using the vehicle information. That is, the vehicle can determine the seat corresponding to the position of the steering wheel recognized from the vehicle information as the driver's seat.

According to the embodiment, the vehicle can receive the vehicle information including the part number of the steering wheel from the air conditioning apparatus. The vehicle can identify whether the vehicle is an LHD vehicle or an RHD vehicle using the part number of the steering wheel.

For example, when the vehicle is identified as an LHD vehicle, the vehicle can determine the seat installed on the left side as the driver's seat, and determine the seat installed on the right side as the passenger seat when the front window is seen from the inside of the vehicle. As another example, when the vehicle is identified as an RHD vehicle, the vehicle can determine the seat installed on the left side as the passenger seat, and determine the seat installed on the right side as the driver's seat when the front window is seen from the inside of the vehicle.

In step 1120, the vehicle can display the positions of the driver's seat and the passenger seat on the screen based on the determination result. According to the embodiment, the vehicle can display the control screen for controlling the air conditioning apparatus through the display. Here, the vehicle can display the control screen for individually controlling the air conditioning apparatus with respect to the driver's seat and the passenger seat such that the user can more conveniently use the air conditioning apparatus.

The vehicle can display the user interface including the information related to the positions of the driver's seat and the passenger seat on the screen through the display such that those aboard the vehicle can more conveniently recognize the information related to the air conditioning apparatus, and input the control order related to the air conditioning apparatus.

The method according to the embodiment may be implemented as a program order that can be performed through various computer means, and may be recorded on a computer-readable recording medium. The computer-readable recording medium may include one or combinations of a program order, a data file, a data structure, and so on. The program order recorded on the medium may be specially designed for the embodiment or may be known and usable by those skilled in the field of computer software. The computer-readable recording medium may include a hardware device specially constituted to store and execute the program order, for example, magnetic media such as a hard disk, a floppy disk and a magnetic tape, optical media such as CD-ROM, DVD, and so on, magneto-optical media such as a floptical disk and so on, a ROM, a RAM, a flash memory, and so on.

The program order includes a machine language code made by a compiler, and a high-level language that can be executed by a computer using an interpreter or the like. The hardware device may be configured to be operated as at least one software module configured to perform the operation of the embodiment, and vice versa.

As is apparent from the above description, a navigation device configured to provide an appropriate display screen at positions of a driver's seat and a passenger seat by adaptively determining the positions of the driver's seat and the passenger seat according to a position at which a steering wheel of a vehicle is installed, a vehicle including the same, and a method of controlling the vehicle are provided.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A navigation device comprising:
a reception unit configured to receive vehicle information including a position of a steering wheel installed in a vehicle;
a determination unit configured to determine positions of a driver's seat and a passenger seat of the vehicle based on the received vehicle information; and
a display unit configured to display the positions of the driver's seat and the passenger seat in the vehicle based on the determination result.

2. The navigation device according to claim 1, wherein the reception unit receives the vehicle information from an air conditioning apparatus of the vehicle through a controller area network (CAN).

3. The navigation device according to claim 1, wherein the vehicle information comprises part information of the steering wheel installed in the vehicle.

4. The navigation device according to claim 1, wherein the reception unit receives the vehicle information transmitted from an air conditioning apparatus after booting of the navigation device is complete, or receives the vehicle information transmitted from the air conditioning apparatus before the booting of the navigation device is complete.

5. The navigation device according to claim 1, wherein the display unit displays the positions of the driver's seat and the passenger seat in the vehicle through the display of the navigation device.

6. The navigation device according to claim 1, wherein the display unit generates a user interface constituting a screen of a display corresponding to the positions of the driver's seat and the passenger seat in the vehicle.

7. The navigation device according to claim 6, wherein the display unit displays the generated user interface on the screen.

8. A vehicle comprising:
a reception unit configured to receive vehicle information including a position of a steering wheel of the vehicle;
a determination unit configured to determine positions of a driver's seat and a passenger seat of the vehicle based on the received vehicle information; and
a display unit configured to display the positions of the driver's seat and the passenger seat in the vehicle based on the determination result.

9. The vehicle according to claim 8, wherein the reception unit receives the vehicle information from an air conditioning apparatus through a CAN.

10. The vehicle according to claim 8, wherein the vehicle information comprises part information of the steering wheel installed in the vehicle.

11. The vehicle according to claim 8, wherein the reception unit receives the vehicle information transmitted from the air conditioning apparatus after booting of a navigation device installed in the vehicle is complete, or receives the vehicle information transmitted from the air conditioning apparatus before the booting of the navigation device is complete.

12. The vehicle according to claim 8, wherein the display unit displays the positions of the driver's seat and the passenger seat in the vehicle through the display of the navigation device installed in the vehicle.

13. The vehicle according to claim 8, wherein the display unit generates a user interface constituting a screen of the display corresponding to the positions of the driver's seat and the passenger seat in the vehicle.

14. The vehicle according to claim 13, wherein the display unit displays the generated user interface on the screen.

15. A method of controlling a vehicle, the method comprising steps of:
receiving vehicle information including a position of a steering wheel of the vehicle;
determining positions of a driver's seat and a passenger seat of the vehicle based on the received vehicle information; and
displaying the positions of the driver's seat and the passenger seat in the vehicle based on the determination result.

16. The method of controlling the vehicle according to claim 15, wherein the step of receiving the vehicle information includes receiving the vehicle information from an air conditioning apparatus through a CAN.

17. The method of controlling the vehicle according to claim 15, wherein the vehicle information comprises part information of the steering wheel installed in the vehicle.

18. The method of controlling the vehicle according to claim 15, wherein step of receiving the vehicle information includes receiving the vehicle information transmitted from the air conditioning apparatus after booting of a navigation device installed in the vehicle is complete, or receiving the vehicle information transmitted from the air conditioning apparatus before the booting of the navigation device is complete.

19. The method of controlling the vehicle according to claim 15, wherein displaying the positions includes generating a user interface constituting a screen of a display to correspond to the positions of the driver's seat and the passenger seat in the vehicle.

20. The method of controlling the vehicle according to claim 19, wherein displaying the positions further comprises displaying the generated user interface on the screen.
